(19) United States
(12) Patent Application Publication
(10) Pub. No.: US 2019/0316243 A1
(43) Pub. Date: Oct. 17, 2019

(54) Nanoporous Copper-Zinc-Aluminum Shape Memory Alloy and Preparation and Application Thereof

(71) Applicant: SOUTH CHINA UNIVERSITY OF TECHNOLOGY, Guangzhou City (CN)

(72) Inventors: Bin Yuan, Guangzhou City (CN); Zheng Luo, Guangzhou City (CN); Jiege Liang, Guangzhou City (CN); Yan Gao, Guangzhou City (CN); Min Zhu, Guangzhou City (CN)

(21) Appl. No.: 16/347,670

(22) PCT Filed: Jan. 31, 2018
(86) PCT No.: PCT/CN2018/074688

§ 371 Date: May 6, 2019

(30) Foreign Application Priority Data
Mar. 9, 2017 (CN) 201710136258.8

(51) Int. Cl. C22F 1/08; C22C 9/04; C22C 1/08; C22C 1/02; H01M 4/80; H01M 4/66; H01M 10/0525

(52) U.S. Cl. CPC C22F 1/08; C22C 9/04; C22C 1/08; B82Y 40/00; H01M 4/80; H01M 4/662; H01M 10/0525; C22C 1/02

(57) ABSTRACT

The present invention discloses a nanoporous copper-zinc-aluminum shape memory alloy and a preparation method and an application thereof. According to the method, firstly a pure Cu block, a pure Zn block and a pure Al block are proportioned in a certain mass ratio before being smelted to obtain a copper-zinc-aluminum alloy ingot; the obtained copper-zinc-aluminum alloy ingot is melt spun using a copper roller rapid quenching method under vacuum protection to obtain an ultrathin strip CuZnAl master alloy which is then subjected to an etching treatment with a solution containing chloride ions at a temperature of 0˜80° C. for 10˜300 minutes to obtain a nanoporous Cu/CuZnAl material; and finally the nanoporous CuZnAl material is sealed in a high vacuum quartz tube for a heat treatment to obtain a nanoporous copper-zinc-aluminum shape memory alloy having a superelastic single β phase at room temperature. The preparation method according to the present invention is highly controllable and can be used in the industry preparing electrode materials for lithium ion secondary batteries to remarkably improve the cyclic performance of electrode materials.

### BACKGROUND OF THE PRESENT INVENTION

### Field of Invention

The present invention relates to a nanoporous copper-zinc-aluminum shape memory alloy and a preparation method and application thereof in the field of nanoporous functional metal materials and lithium ion secondary batteries.

### Description of Related Arts

Lithium ion secondary batteries enable the mutual conversion of electric energy and chemical energy through the process of intercalation and deintercalation of lithium ions between the positive and negative electrodes, and have been attracting the attention of researchers and the industrial community all around the world due to their high energy density, good cyclic performance, environmental friendly with no pollution, and long service life.

The capacity and cycle life of a lithium ion secondary battery are mainly determined by the positive and negative electrode materials. However, those positive electrode materials that have been developed so far have not much different theoretical capacities, and each has its own advantages and disadvantages with limited room for improvement. As a result, more attention has been shifted to new high-capacity negative electrode materials with more room for improvement. Graphite negative electrode materials now used commercially have a theoretical capacity of only 372 mAh/g, which is far from satisfying the demand for mobile power. New high-capacity negative electrode materials such as Si, SiOₓ, Sn and SnO₂ have much higher theoretical capacities than graphite negative electrode materials. However, by now these new high-capacity negative electrode materials are still not in a position to replace graphite negative electrode materials, mainly because of their poor cycle life. These high-capacity negative electrode materials may undergo significant volume changes during the intercalation and deintercalation of lithium ions, for example, 320% volume expansion after lithium insertion in Si, which easily causes pulverization and cracking of the negative electrode material and consequently loss of good contact with the current collector. As a result, the capacity sharply decays and the cyclic performance deteriorates. At present, methods for mitigating the volume expansion of new high-capacity negative electrode materials mainly include nanocrystallization, multiphase composite and construction of three-dimensional porous current collectors.

Firstly, nanocrystallization is to refine the negative electrode material to the nanometer level, which can reduce the absolute volume change generated during charge and discharge, and contribute to the improvement of cyclic performance to a certain extent, but the nano negative electrode material is prone to agglomeration and its cyclic performance will also deteriorate sharply after several cycles. Secondly, multiphase composite is to evenly disperse the negative electrode material into the matrix of a second phase, such as carbon, metal material or amorphous oxide. The second phase can not only buffer the volume change of the negative electrode material in the process of intercalation and deintercalation of lithium ions, but also limit the agglomeration of nano-active particles, thereby well improving the cyclic performance, so multiphase composite is also a general method for newly developing high-capacity negative electrode materials. However, this method only allows a limited capacity increase, and since the second phase cannot effectively alleviate the internal stress caused by the volume expansion, the negative electrode material may still undergo cracking and pulverization after repeated cycles. Therefore, researchers have recently focused on a superelastic shape memory alloy matrix that is based on the stress-induced martensitic transformation and can completely eliminate large strains (up to 18%), thus exhibiting excellent cyclic performance. However, addition of a shape memory alloy at a high proportion is required as well, resulting in a lower overall capacity of the negative electrode material, and too much shape memory alloy will reduce the diffusion rate of lithium ions, thereby affecting the rate capability. Thirdly, construction of three-dimensional porous current collectors intends to take advantage of pores to alleviate volume expansion. So far, researchers have done a lot of experimental research on nanoporous copper, nanoporous nickel, or commercial copperinickel foam, all of which show that the porous structure has certain effect on alleviating the volume expansion of high-capacity negative electrode materials, but the porous current collector matrix itself does not have the effect of buffering strain and stress, and thus after filling a certain amount of negative electrode materials, the pore wall will still undergo plastic deformation or even crack after multiple cycles, resulting in a decline in the cyclic performance.

In conclusion, at present, none of the above methods alone can solve the conflict between the cyclic performance and the overall negative electrode specific capacity of these new high-capacity negative electrode materials. One of the reasons is that they all fail to efficiently utilize the material and three-dimensional structure of the current collector to eliminate the enormous stress caused by the new negative electrode material during the intercalation process of lithium ions and to increase the loading rate of unit active phase.

The applicants filed a Chinese invention patent application CN201510974645.X in December 2015, which discloses a method for preparing a micro/nano two-scale porous Cu/β composite material with a dealloying treatment followed by a heat treatment. The method comprises the steps of proportioning a pure Cu block, a pure Zn block and a pure Al block and smelting the resultant to obtain a copper-zinc-aluminum alloy ingot; putting the copper-zinc-aluminum alloy ingot into a vacuum furnace and carrying out an annealing treatment under protective atmosphere to obtain a copper-zinc-aluminum master alloy as annealed; melt-spinning the copper-zinc-aluminum master alloy using a copper roller rapid quenching method under vacuum protection to obtain an ultra-thin ribbon CuZnAl alloy; carrying, out a dealloying treatment with a hydrochloric acid ferric chloride solution at a temperature of room temperature to 95° C. for 30-1800 minutes to obtain a micro/nano porous CuZnAl composite material; and putting the micro/nano porous CuZnAl composite material into a vacuum furnace and carrying out a quenching heat treatment under protective atmosphere to obtain a micro/nano porous CuZnAl shape memory alloy composite material. Although the preparation method disclosed by the invention is high in controllability and simple in operation, and the industrial production thereof is easy to implement, the applicants, after in-depth research on the basis of previous study, have found that the air cannot be completely isolated as the heat treatment in the invention is carried out in a vacuum tube furnace under the protection of argon or nitrogen, so the nanoporous copper on the surface of the sample is easily oxidized to hinder internal Zn and Al from diffusing to the surface, and a composite material mainly composed of pure Cu with a small amount of β phase is obtained instead of a porous single β-CuZnAl shape memory alloy current collector. Thus, it does not embody the great advantage of superelasticity of the shape memory alloy in buffering the volume expansion of the negative electrode material.

### SUMMARY OF THE PRESENT INVENTION

In order to overcome the shortcomings and deficiencies of the prior art, the present invention aims to provide a nanoporous copper-zinc-aluminum shape memory alloy and a preparation method thereof, wherein a diffusion heat treatment is carried out on a nanoporous CuZnAl alloy with different etching solutions and heat treatment methods to prepare a nanoporous CuZnAl shape memory alloy having a single β phase at room temperature, the alloy composition and phase transformation temperature can be well regulated, and using this material as a current collector to alleviate volume change of the high-capacity negative electrode material during charge and discharge can effectively achieve the purpose of improving the capacity and cyclic performance of lithium ion batteries.

Another object of the present invention is to provide applications of the nanoporous copper-zinc-aluminum shape memory alloy in secondary battery electrode materials or catalyst carriers.

The invention prevents oxidation of the pure copper layer on the surface after the formation of nanoporosity by a high vacuum sealing heat treatment, which is favorable for the diffusion of Zn and Al, and finally prepares a nanoporous CuZnAl shape memory alloy having a single β phase at room temperature. The single-phase nanoporous CuZnAl shape memory alloy exhibits excellent superelastic properties as a current collector, and after filling a high-capacity negative electrode material, sufficient pores and super-elasticity of the copper-zinc-aluminum memory alloy can accommodate huge volume expansion. The nanoporous copper-zinc-aluminum memory alloy prepared by the invention has good ductility, electrical conductivity and thermal conductivity that sufficiently meet the requirements for a current collector, and is cheap and convenient to process.

The Objects of the Present Invention are Achieved by the Following Technical Solutions:

A preparation method of a nanoporous copper-zinc-aluminum shape memory alloy, comprising the steps of:

(1) smelting raw materials of pure Cu, pure Zn and pure Al to prepare a CuZnAl alloy ingot, with a mass ratio of each element in the CuZnAl alloy ingot Cu:Zn:Al=(100−X−Y): X:Y, wherein X is 26˜35 and Y is 5˜7;

(2) melt spinning the CuZnAl alloy ingot obtained in the step (1) using a copper roller rapid quenching method under vacuum protection to obtain an ultrathin strip CuZnAl master alloy;

(3) subjecting the ultrathin strip CuZnAl master alloy obtained in the step (2) to an etching treatment in a solution containing chloride ions to obtain a nanoporous Cu/CuZnAl composite material;

(4) sealing the nanoporous Cu/CuZnAl composite material obtained in the step (3) in a high vacuum quartz tube for a heat treatment to obtain a nanoporous CuZnAl shape memory alloy having a single β phase, the high vacuum quartz tube having a vacuum degree of 1×10⁻²˜5×10⁻⁴ Pa.

To further achieve the objects of the present invention, preferably, the raw materials of pure Cu, pure Zn and pure Al in the step (1) have a purity of 99% or more by mass percentage.

Preferably the CuZnAl alloy ingot of the step (1) prepared by an induction melting method or an arc melting method.

Preferably, in the copper roller rapid quenching method of the step (2), a rotational speed of the copper roller is 1000˜4000 rpm, and a vacuum degree under the vacuum protection is 0.1˜10 Pa.

Preferably, the ultrathin strip CuZnAl master alloy in the step (2) has a thickness of 10˜200 μm and a width of 3˜20 mm.

Preferably, the solution containing chloride ions in the step (3) is an aqueous solution or an organic solution with a chloride ion concetration of 0.1˜10 wt. %.

Preferably, the etching treatment in the step (3) is carried out at a temperature of 0˜80° C. for 10˜300 minutes.

Preferably, the heat treatment in the step (4) is carried out in a muffle furnace or a tube furnace at a heating temperature of 600˜900° C. for 0.5˜10 h, and after the heat treatment, the quartz tube is quenched into water before being broken up and cooled.

A nanoporous copper-zinc-aluminum shape memory alloy which is prepared by said preparation method.

Application of the nanoporous copper-zinc-aluminum shape memory alloy in secondary battery electrode materials or catalyst carriers.

The principle of the invention is that the thin strip sample prepared by the copper roller rapid quenching method is mainly composed of a β phase and a γ phase. Both the β phase and the γ phase are alloy phases composed of the three elements of Cu, Zn and Al, the β phase is the only phase that exhibits a shape memory effect or superelasticity and has a smaller Zn content than the γ phase, and the γ phase is a Zn-rich phase. The electrode potential of Zn is −0.76V, which is lower than that of Cu (+0.34V), indicating that the activity of Zn is higher than that of Cu. During chemical etching, Zn atoms in the β phase and the γ phase are preferentially etched away in a solution containing chloride ions, leaving Cu and Al atoms and thereby obtaining nanopores, and the nanopores will gradually grow with time to a diameter of 15 to 500 nm. The applicants found that etching is a process from the surface to the inside, after the surface is etched, a layer of porous pure copper on a nanometer scale is obtained, but it does not have superelasticity, therefore a further heat treatment is required to thermally diffuse the internal Zn and Al elements to the porous layer of the surface, and since the diffusion speed of Zn and Al is much faster than that of Cu, Zn and Al atoms diffuse from the inside to the surface porous layer whereas Cu in the surface porous layer does not diffuse significantly during the heat treatment, so the, porous layer on the surface will gradually converted to a β phase and the nanoporous structure remains. However, the nanoporous surface of the sample after etching is easily oxidized during the heat treatment to form copper oxide, which is not conducive to further diffusion of Zn and Al atoms to form the β phase, and it cannot be prevented from being oxidized even if it is heat-treated under a protective gas atmosphere in a tube furnace. The vacuum sealing process is to seal the sample in a quartz tube, the small internal space of the quartz tube allows the vacuum degree to reach 1×10⁻²˜5×10⁻⁴ Pa after vacuuming, and thus oxidation of the porous copper layer on the surface can be effectively prevented during the heat treatment so as to finally prepare a single β phase.

The Present Invention Has the Following Advantages and Beneficial Effects Over the Prior Art:

(1) The nanoporous copper-zinc-aluminum shape memory alloy prepared by the present invention has a single β phase at room temperature and exhibits superelasticity.

(2) The nanoporous β-CuZnAl shape memory alloy current collector prepared by the invention has a three-dimensionally interconnected pore structure, and the nanopores not only can limit the size of the active material, but also have a high specific surface area to load more active substances; and the single β phase CuZnAl porous shape memory alloy has good superelasticity, can effectively alleviate volume expansion of the high capacity negative electrode material, and can improve the overall capacity and cycle life of lithium/sodium ion batteries.

(3) The composition of the nanoporous copper-zinc-aluminum shape memory alloy prepared by the invention can be regulated by controlling composition of the copper-zinc-aluminum master alloy, etching time and heat treatment temperature, and the method is simple, controllable, and suitable for mass production.

### BRIEF DESCRIPTION OF THE DRAWINGS

FIG. 1 is an X-ray diffraction (XRD) pattern of the original copper-zinc-aluminum thin strip sample in Embodiment 1;

FIG. 2 is a pore surface morphology of the copper-zinc-aluminum thin strip sample in Embodiment 1 after being subjected to etching for 90 minutes;

FIG. 3 is an XRD pattern of the copper-zinc-aluminum thin strip sample in Embodiment 1 after being subjected to etching for 90 minutes, high vacuum heat reservation at 850° C. for 3 hours and quenching;

FIG. 4 is a SEM surface morphology of the copper-zinc-aluminum thin strip sample in Embodiment 1 after being subjected to etching for 90 minutes, high vacuum heat reservation at 850° C. for 3 hours and quenching;

FIG. 5 shows a DSC curve of the copper-zinc-aluminum thin strip sample of Embodiment 1 after being subjected to etching for 90 minutes, high vacuum heat reservation at 850° C. for 3 hours and quenching;

FIG. 6 is an XRD pattern of the copper-zinc-aluminum thin strip sample of Embodiment 1 after being subjected to etching for 90 minutes, high vacuum heat reservation at 850° C. for 3 hours, quenching, and electroless tin plating;

FIG. 7 is a surface morphology of the copper-zinc-aluminum thin strip sample of Embodiment 1 after being subjected to etching for 90 minutes, high vacuum heat reservation at 850° C. for 3 hours, quenching, and electroless tin plating:

FIG. 8 shows the first three charge and discharge curves of the copper-zinc-aluminum thin strip sample of Embodiment 1 after being subjected to etching for 90 minutes, high vacuum heat reservation at 850° C. for 3 hours, quenching, and electroless tin plating:

FIG. 9 a surface morphology of the copper-zinc-aluminum thin strip sample in Embodiment 2 after being subjected to etching for 240 minutes, high vacuum heat reservation at 650° C. for 10 hours, and quenching:

FIG. 10 is a surface morphology of the copper-zinc-aluminum thin strip sample in Embodiment 3 after being subjected to etching for 120 minutes, high vacuum heat reservation at 750° C. for 6 hours, and quenching.

### DETAILED DESCRIPTION OF THE PREFERRED EMBODIMENT

In order to better understand the present invention, it will be further described below in conjunction with the embodiments and the accompanying drawings, but the embodiments of the present invention are not limited thereto.

### Embodiment 1

(1) A pure copper block, a pure zinc block and a pure aluminum block are weighed according to a mass ratio of 60:34:6, and then are subjected to induction melting to obtain a copper-zinc-aluminum alloy ingot.

(2) The copper-zinc-aluminum alloy ingot obtained in the step (1) is melt spun using a copper roller rapid quenching method under vacuum protection to obtain an ultrathin strip CuZnAl precursor having a γ phase (with characteristic peaks of 43.2, 62.7 and 79.2 degrees) and a small amount of β phase (with characteristic peaks of 43.5, 63.0 and 79.6 degrees), the XRD pattern of which is shown in FIG. 1. For the copper roller rapid quenching, the vacuum degree is 0.1 Pa, the rotational speed of the copper roller is 4000 rpm, the thickness of the strip is 20 μm, and the width of the material is 5 mm.

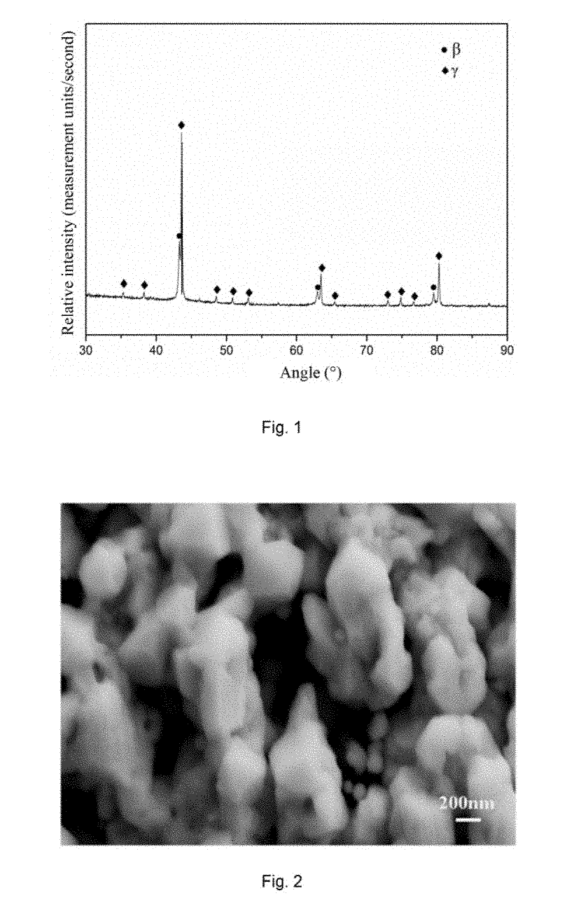

(3) The ultrathin strip CuZnAl master alloy having both β and γ phases which is obtained in the step (2) is etched in an aqueous solution of ferric chloride hydrochloride having a mass percentage of 5 wt. % (5 wt. % hydrochloric acid, 5 g of ferric chloride per 100 ml) at a temperature of 30° C. for 90 min to obtain a nanoporous Cu/CuZnAl composite material. It can be seen from the SEM of the surface (FIG. 2) that the pore sizes of the nanopores are about 200˜300 nm.

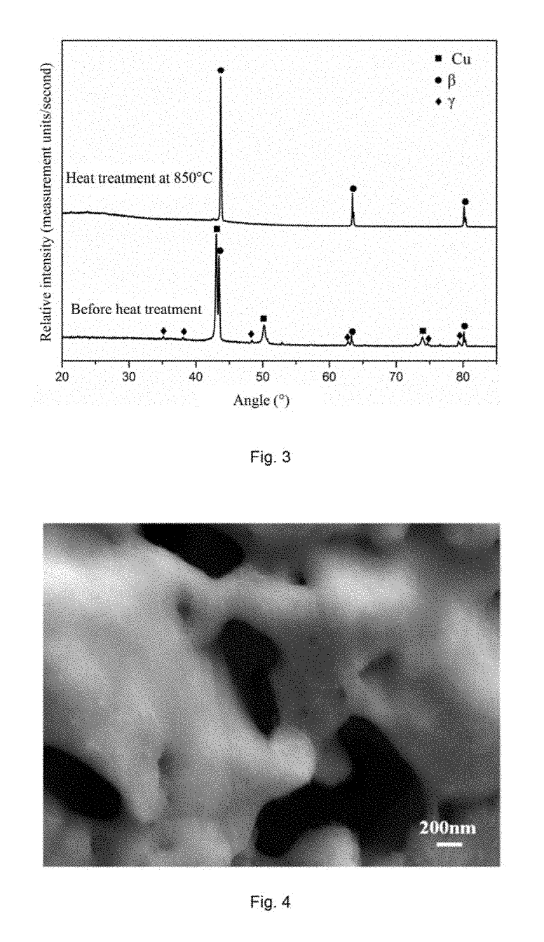

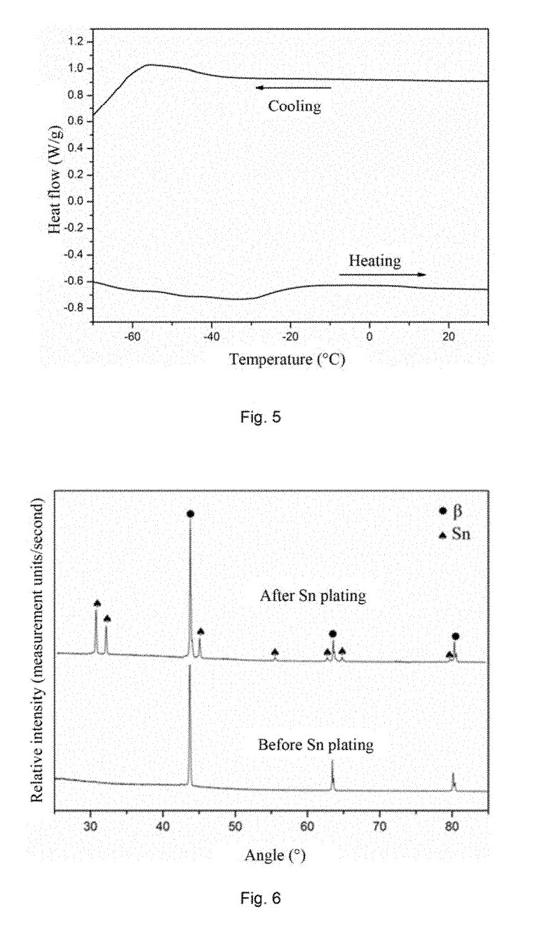

(4) The porous Cu/CuZnAl composite material with nanometer-scale pore sizes which is obtained in the step (3) is sealed into a high vacuum quartz tube, and the quartz tube is vacuum pumped by a vacuum system at a vacuum degree on the order of 5×10⁻⁴ Pa. After vacuuming the quartz tube, its mouth is melted by heating to be sealed. The sealed quartz tube is placed in a muffle furnace for a heat treatment at a temperature of 850° C. for a heat holding time of 3 h, and then is quenched into water before being broken up and cooled. The phase structure of the sample after the high vacuum heat treatment at 850° C. has changed significantly, as the phase changes from the former phase dominated by a pure copper phase to a single β phase, as shown in FIG. 3. Test results show that, compared with the heat treatment in the Chinese invention patent CN201510974645.X, the heat treatment under high vacuum condition significantly improves diffusion of internal Zn and Al atoms into the porous copper layer so that a single β phase is prepared. FIG. 4 shows the surface morphology of the sample after the the high vacuum heat treatment at 850° C., and the pore sizes range from tens of nanometers to hundreds of nanometers. The DSC results (FIG. 5) show that the martensite critical transformation temperature of the sample after the heat treatment at 850° C. is −35° C., further demonstrating that the prepared β-CuZnAl has a parent phase at room temperature and has superelasticity. The sample prepared in the Chinese invention patent CN201510974645.X has a low β phase content, and accordingly the martensite transformation point cannot be measured by DSC, which means that no martensite transformation occurs, so the whole composite material exhibits almost no superelasticity.

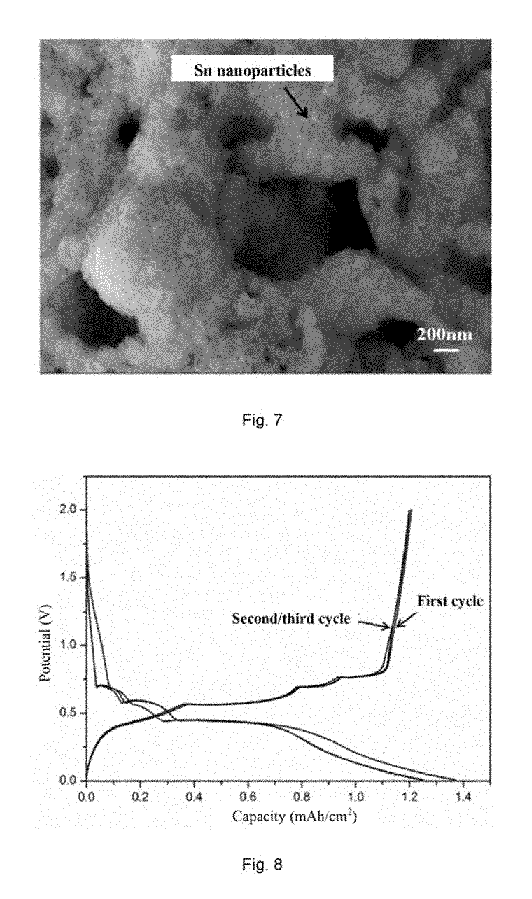

The prepared nanoporous β-CuZnAl shape memory alloy current collector is immersed in an electroless tin plating solution with a composition of NaOH at 2.8 mol/L, SnSO₄ at 0.3 mol/L, NaH₂PO₄ at 0.9 mol/L and Na₃C₆H₅O₇ at 0.6 mol/L for 3 minutes at room temperature to obtain a nanoporous β-CuZnAl/Sn composite electrode. The composite electrode after tin plating is washed with deionized water and then dried in a vacuum drying oven for 8 hours. The XRD pattern of the obtained composite negative electrode material (FIG. 6) shows that significant tin diffraction peaks (characteristic peaks of 30.6°, 32.0°, and 44.9°) occur after electroless tin plating. It can be seen from its surface morphology after tin plating (FIG. 7) that some of the small pores are filled with nano-sized tin particles, but the porous structure remains and can serve as a channel for lithium ion diffusion.

In a glove box, the prepared composite negative electrode material functioning as a positive electrode, PE as a separator, a metal lithium plate as a negative electrode, and ethylene carbonate as an electrolyte are pressed into a button battery having a diameter of 12 mm to compose a half cell. The prepared half cell is tested for charge and discharge performance in a Land battery test system, and the first three charge and discharge curves are shown in FIG. 8, which result is measured on a Land battery test system with specific parameters as follows: the current density is 1 mA/cm², and the charge and discharge voltage ranges from 0.01 V to 2 V. As can be seen from the figure, the first capacity reached 1.35 mAh/cm², the first Coulombic efficiency is 87.7%, the irreversible capacity after one cycle is only 8.6% of the original capacity, and the capacity remained at 1.18 mAh/cm² after ten cycles, that is 87.6% of the initial capacity, showing excellent cycle stability and high capacity. By comparison, in the battery test results of the Chinese invention patent CN01510974645.X, the first Coulombic efficiency is only 60%, the irreversible capacity after one cycle is 36.4%, and the capacity after ten cycles decays to 33.7% of the initial capacity. Therefore, the present invention not only greatly improves the first Coulombic efficiency of the Sn-based negative electrode material of lithium ion batteries, but also significantly improves the cycle performance, which indicates that the single β phase nanoporous CuZnAl shape memory alloy prepared by the present invention is a current collector, it has superelasticity at room temperature, can further alleviate the volume expansion of the Sn-based negative electrode material during the cycle, significantly improve the capacity, Coulombic efficiency and cycle performance of lithium ion batteries, and has great application value in the field of lithium or sodium ion batteries.

### Embodiment 2

(1) A pure copper block, a pure zinc block and a pure aluminum block are weighed according to a mass ratio of 61:32:7, and then are subjected to induction melting to obtain is a copper-zinc-aluminum alloy ingot.

(2) The copper-zinc-aluminum alloy ingot obtained in the step (1) is melt spun using a copper roller rapid quenching method under vacuum protection to obtain an ultrathin strip CuZnAl master alloy having a γ phase and a small amount of β phase. For the copper roller rapid quenching, the vacuum degree is 1 Pa, the rotational speed of the copper roller is 3000 rpm, the thickness of the strip is 40 μm, and the width of the material is 10 mm.

(3) The ultrathin strip CuZnAl master alloy having both β and γ phases which is obtained in the step (2) is etched in an alcohol solution with a chloride ion concentration of 3% at a temperature of 80° C. for 240 min.

(4) The porous Cu/CuZnAl composite material with nanometer-scale pore sizes which is obtained in the step (3) is sealed into a quartz tube, and the quartz tube is vacuum pumped by a vacuum system at a vacuum degree on the order of 1×10⁻³ Pa. After vacuuming the quartz tube, its mouth is melted by heating to be sealed. The sealed quartz tube is placed in a muffle furnace for a heat treatment at a temperature of 650° C. for a heat holding time of 10 h, and then is quenched into water to get cooled. The phase structure of the sample after the high vacuum heat treatment has changed significantly, as the phase changes from the former phase dominated by a pure copper phase to a single β phase. FIG. 9 shows the surface morphology of the sample after the heat treatment at 650° C. and the pore sizes are 50˜500 nm or so. The specific surface area of the sample is measured by BET, wherein heat preservation is first carried out at 200° C. is for 2 h for degassing, which is followed by cooling with liquid nitrogen as a coolant, then an adsorption experiment is conducted, and the result of specific surface area is directly obtained from the instrument measurement data. The test results show that the nanoporous β-CuZnAl shape memory alloy prepared by the heat treatment at 650° C. has a specific surface area of as high as 2.988 m²/g. The high specific surface area facilitates loading more catalyst, and in addition, the porous structure is beneficial to the contact between reactants and catalysts, thereby improving the reaction efficiency. Therefore, the present invention has great advantages in its use as a catalyst carrier.

### Embodiment 3

(1) A pure copper block, a pure zinc block and a pure aluminum block are weighed according to a mass ratio of 60:35:5, and then are subjected to arc melting to obtain a copper-zinc-aluminum alloy ingot.

(2) The copper-zinc-aluminum alloy ingot obtained in the step (1) is melt spun using a copper roller rapid quenching method under vacuum protection to obtain an ultrathin strip CuZnAl master alloy having a γ phase and a small amount of β phase. For the copper roller rapid quenching, the vacuum degree is 0.5 Pa, the rotational speed of the copper roller is 2000 rpm, the thickness of the strip is 60 μm, and the width of the material is 3 mm.

(3) The ultrathin strip CuZnAl master alloy having both β and γ phases which is obtained in the step (2) is etched in an aqueous hydrochloric acid solution having a chloride ion concentration of 1 wt. % at a temperature of 50° C. for 120 min to obtain a nanoporous Cu/CuZnAl composite material.

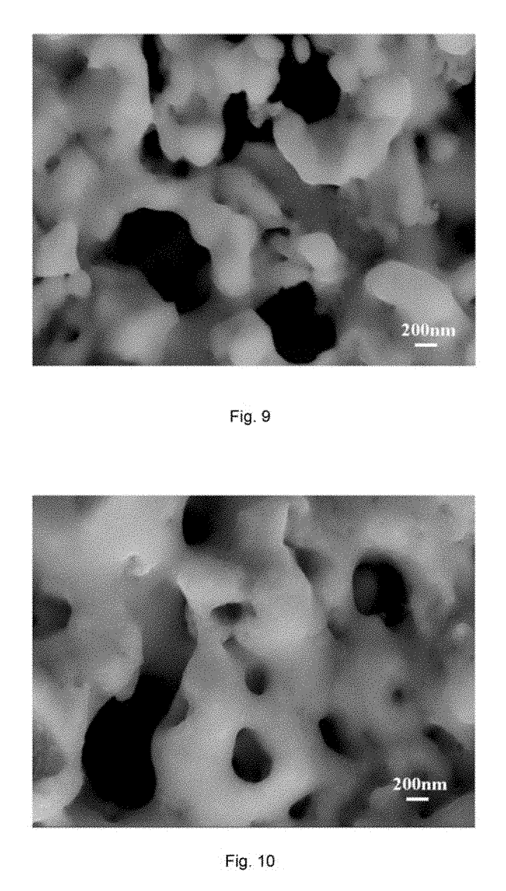

(4) The porous Cu/CuZnAl composite material with nanometer-scale pore sizes which is obtained in the step (3) is sealed into a quartz tube, and the quartz tube is vacuum pumped by a vacuum system at a vacuum degree on the order of 5×10⁻³ Pa. After vacuuming the quartz tube, its mouth is melted by heating to be sealed. The sealed quartz tube is placed in a tube furnace for a heat treatment at a temperature of 750° C. for a heat holding time of 6 h, and then is quenched into water before being broken up and cooled. The phase structure of the sample after the high vacuum heat treatment at 750° C. has changed significantly, as the phase changes from the former phase dominated by a pure copper phase to a single β phase. FIG. 10 shows the surface morphology of the sample after the high vacuum heat treatment at 750° C. and the pore sizes range from tens of nanometers to hundreds of nanometers.

1. A preparation method of a nanoporous copper-zinc-aluminum shape memory alloy, comprising the steps of:
(1) smelting raw materials of pure Cu, pure Zn and pure Al to prepare a CuZnAl alloy ingot, with a mass ratio of each element in the CuZnAl alloy ingot Cu:Zn:Al=(100−X−Y): X:Y, wherein X is 26˜35 and Y is 5˜7;
(2) melt spinning the CuZnAl alloy ingot obtained in the step (1) using a copper roller rapid quenching method under vacuum protection to obtain an ultrathin strip CuZnAl master alloy;
(3) subjecting the ultrathin strip CuZnAl master alloy obtained in the step (2) to an etching treatment in a solution containing chloride ions to obtain a nanoporous Cu/CuZnAl composite material;
(4) sealing the nanoporous Cu/CuZnAl composite material obtained in the step (3) in a high vacuum quartz tube for a heat treatment to obtain a nanoporous CuZnAl shape memory alloy having a single β phase, the high vacuum quartz tube having a vacuum degree of 1×10⁻²˜5×10⁻⁴ Pa.

2. The preparation method of a nanoporous copper-zinc-aluminum shape memory alloy according to claim 1, wherein the raw materials of pure Cu, pure Zn and pure Al in the step (1) have a purity of 99% or more by mass percentage.

3. The preparation method of a nanoporous copper-zinc-aluminum shape memory alloy according to claim 1, wherein the CuZnAl alloy ingot of the step (1) is prepared by an induction melting method or an arc melting method.

4. The preparation method of a nanoporous copper-zinc-aluminum shape memory alloy according to claim 1, wherein, in the copper roller rapid quenching method of the step (2), a rotational speed of the copper roller is 1000˜4000 rpm, and a vacuum degree under the vacuum protection is 0.1˜10 Pa.

5. The preparation method of a nanoporous copper-zinc-aluminum shape memory alloy according to claim 1, wherein the ultrathin strip CuZnAl master alloy in the step (2) has a thickness of 10˜200 μm and a width of 3˜20 mm.

6. The preparation method of a nanoporous copper-zinc-aluminum shape memory alloy according to claim 1, wherein the solution containing chloride ions in the step (3) is an aqueous solution or an organic solution with a chloride ion concentration of 0.1˜10 wt. %.

7. The preparation method of a nanoporous copper-zinc-aluminum shape memory alloy according to claim 1, wherein the etching treatment in the step (3) is carried out at a temperature of 0˜80° C. for 10˜300 minutes.

8. The preparation method of a nanoporous copper-zinc-aluminum shape memory alloy according to claim 1, wherein the heat treatment in the step (4) is carried out in a muffle furnace or a tube furnace at a heating temperature of 600˜900° C. for 0.5˜10 h, and after the heat treatment, the quartz tube is quenched into water before being broken up and cooled.

9. A nanoporous copper-zinc-aluminum shape memory alloy which is prepared by the preparation method according to claim 1.

10. Application of the nanoporous copper-zinc-aluminum shape memory alloy according to claim 9 in secondary battery electrode materials or catalyst carriers.
